(19) United States
(12) Patent Application Publication
(10) Pub. No.: US 2008/0239902 A1
(43) Pub. Date: Oct. 2, 2008

(54) INFORMATION RECORDING APPARATUS AND INFORMATION RECORDING METHOD

(76) Inventor: Shigetoshi HIRAI, Hiratsuka-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/861,855

(22) Filed: Sep. 26, 2007

(30) Foreign Application Priority Data
Sep. 29, 2006 (JP) 2006-269390

(51) Int. Cl. G11B 5/58

(52) U.S. Cl. 369/53.17

(57) ABSTRACT

According to one embodiment, an information recording apparatus comprises a recording unit which records information in blocks in a rewritable medium, a buffer which stores recording information of blocks while performing update, and stops the update of information when the write error is detected, an identifying unit configured to play back recording information of the information recording medium corresponding to the blocks when the write error is detected, and to identify a block including a write error occurring position based on whether a playback of the recording information has succeeded or not, and a re-recording unit configured to re-record the block identified by the identifying unit.

### CROSS-REFERENCE TO RELATED APPLICATIONS

This application is based upon and claims the benefit of priority from Japanese Patent Application No. 2006-269390, filed Sep. 29, 2006, the entire contents of which are incorporated herein by reference.

### BACKGROUND

1. Field

One embodiment of the invention relates to an information recording apparatus and an information recording method using a rewritable optical disk.

2. Description of the Related Art

Conventional information recording apparatuses using a rewritable optical disk (such as a CD-RW) determine after information recording whether recording has been normally performed or not (whether a write error has occurred or not), and perform recording again when a write error occurs (for example, refer to Jpn. Pat. Appln. KOKAI Pub. No. 2002-216352 (paragraphs 0057 to 0062)).

In the apparatuses, if a write error is detected when data of a predetermined unit is being recorded, recording is performed again from the position of starting recording of the data of the predetermined unit, without performing recovery processing of the recording area in which the write error is detected. Therefore, processing load incurred for recovering the recording area in which the error is detected is reduced, and recording can be efficiently performed. Further, no recovery processing is performed for the recording area in which a write error is detected, and thus the recording area can be dealt with as a normal recording area when data recording is performed again.

However, the data recording unit of optical disks such as DVDs is 1 ECC block (16 data sectors=33024 bytes), which is smaller than a track and a packet which are the recording units of CD-RWs. When a recording unit is small, it is not ensured that the head is positioned on a recording unit including a write error when the write error is detected. Specifically, when a write error is detected, it is possible that the head is positioned on a next recording unit following a recording unit including the write error. Therefore, the write error may not be compensated by simply performing recording again on the recording unit in which the write error has occurred.

As described above, when a write error is detected, there is the possibility that conventional information recording apparatuses cannot identify a recording unit including a write error, and cannot deal with the recording unit including the write error as a normal recording area by performing rewriting on the recording unit including the write error.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram illustrating an optical disk apparatus according to the first embodiment of the present invention;

FIG. 2 is an exemplary flowchart illustrating recording retry processing according to the first embodiment of the present invention;

FIGS. 3A and 3B are exemplary diagrams illustrating data in a data buffer and recorded data on a disk;

FIG. 4 is an exemplary flowchart illustrating recording retry processing according to a second embodiment of the present invention; and

FIG. 5 is an exemplary flowchart illustrating recording retry processing according to a third embodiment of the present invention.

### DETAILED DESCRIPTION

Various embodiments according to the invention will be described hereinafter with reference to the accompanying drawings. In general, according to one embodiment of the invention, an information recording apparatus comprises a recording unit configured to record information in blocks of a predetermined size in a rewritable information recording medium; a write error detector configured to detect a write error; a buffer configured to store recording information of blocks while performing update, and to stop the update of information when the write error detector detects the write error; an identifying unit configured to play back recording information of the information recording medium corresponding to the blocks stored in the buffer when the write error detector detects the write error, and to identify a block including a write error occurring position based on whether a playback of the recording information has succeeded or not; and a re-recording unit configured to re-record the block identified by the identifying unit.

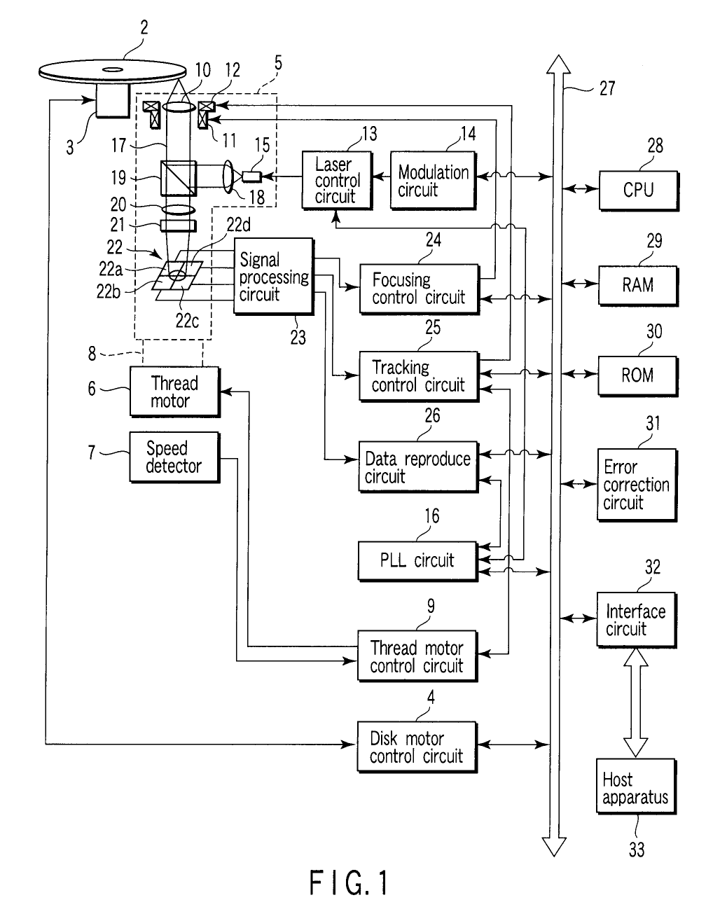

According to an embodiment, FIG. 1 shows a diagram illustrating a configuration of an optical disk apparatus serving as an information recording apparatus according to the first embodiment of the present invention.

Land tracks and groove tracks are formed in a spiral manner on an information recording surface of a rewritable optical disk 2. Examples of the optical disk 2 are a DVD-RW, and DVD+RW. The optical disk 2 is rotated and driven by a spindle motor 3.

An optical pickup 5 (a part enclosed by a broken line in the left part of FIG. 1) performs recording and reproduce of information with respect to the optical disk 2. The optical pickup 5 is connected to a thread motor 6 through a gear 8. The thread motor 6 is controlled by a thread motor control circuit 9.

A speed detector 7 positioned below the thread motor 6 detects a moving speed of the optical pickup, and is connected to the thread motor control circuit 9. A speed signal of the optical pickup 5 detected by the speed detector 7 is transmitted to the thread motor control circuit 9. A permanent magnet (not shown) is provided on a fixed part of the thread motor 6. A drive coil of the thread motor 6 is energized by the thread motor control circuit 9, and thereby the optical pickup 5 is driven in the radial direction of the optical disk 2.

The optical pickup 5 is provided with an objective lens 10 supported by wire or a leaf spring (not shown). The objective lens 10 is movable in a focusing direction (along the optical axis of the lens) and a tracking direction (perpendicular to the optical axis of the lens) by drive of a focusing coil 11 and a tracking coil 12. A layer jump is performed by moving the lens 10 in the focusing direction (along the optical axis of the lens).

A modulation circuit 14 receives an information signal to be recorded from a host apparatus 33 through an interface circuit 32 and a bus 27 when information is recorded on the optical disk 2, and modulates the signal by a modulation method (for example, 8-16 modulation) specified by the standard of the optical disk 2. A laser control circuit 13 supplies a write signal to a semiconductor laser diode 15 on the basis of modulation data supplied from the modulation circuit 14, when information is recorded on the optical disk 2 (when a mark is formed). When information is reproduced, the laser control circuit 13 supplies a read signal which is smaller than a write signal to the semiconductor laser diode 15.

The semiconductor laser diode 15 generates laser light in response to a signal supplied from the laser control circuit 13. The laser light generated from the semiconductor laser diode 15 is applied onto the optical disk 2 through a collimator lens 18, a half prism 19, and the objective lens 10. Reflected light from the optical disk 2 is introduced into an optical detector 22 through the objective lens 10, the half prism 19, a condenser lens 20, and a cylindrical lens 21.

The optical detector 22 comprises, for example, four-split optical detection cells 22a to 22d. Output signals of the optical detection cells 22a to 22d of the optical detector 22 are supplied to a signal processing circuit 23, and subjected to the following signal processing. Output signals of the optical detection cells 22a to 22d are subjected to addition and subtraction through a current/voltage conversion amplifier, and thereby a reproduce signal, a focus error signal FE, and a tracking error signal TE are obtained.

The focus error signal FE is supplied to a focusing control circuit 24, and thereby a focusing drive signal is generated. The focusing drive signal output from the focusing control circuit 24 is supplied to the focusing coil 11, and focusing control of the objective lens 10 is performed such that laser light is always focused just on the recording surface of the optical disk 2.

The tracking error signal TE is supplied to a tracking control circuit 25, and thereby a tracking drive signal is generated. The tracking drive signal output from the tracking control circuit 25 is supplied to the tracking coil 12, and tracking control of the objective lens 10 is performed such that laser light is always located on a target track on the recording surface of the optical disk 2. The tracking drive signal is also supplied to the thread motor control circuit 9.

The reproduce signal is supplied to a data reproduce circuit 26. The data reproduce circuit 26 plays back read recording data on the basis of a reproduce clock signal from a PLL circuit 16. Further, the data reproduce circuit 26 has a measurement function of measuring amplitude of the reproduce signal, and a measured value is output to a CPU 28 through the bus 27.

The thread motor control circuit 9 controls the thread motor 6, and moves the main body of the optical pickup 5 such that the objective lens 10 is positioned in the vicinity of the central position in the optical pickup 5.

The disk motor control circuit 4, the thread motor control circuit 9, the modulation circuit 14, the laser control circuit 13, the PLL circuit 16, the data reproduce circuit 26, the focusing control circuit 24 and the tracking control circuit 25 can be formed in one LSI chip. These circuits are controlled by the CPU 28 through the bus 27. The CPU 28 performs overall control of the optical disk recording and reproduce apparatus, in accordance with operation commands supplied from the host apparatus 33 through the interface circuit 32. The CPU 28 uses a RAM 29 as a work area, and performs predetermined control in accordance with a program recorded on a ROM 30 and including processing according to the embodiments of the present invention.

The following is explanation of information recording performed by the optical disk apparatus of FIG. 1. Information to be recorded is supplied from the host apparatus 33 to the error correction circuit 31 through the interface circuit 32, and temporarily stored in a data buffer (not shown) in the RAM 29. In the error correction circuit 31, the data is divided into sectors each having 172 bytes×12 rows, error detection and correction (ECC) information is added to every 16 sectors, and thereby ECC blocks are formed. Data of each ECC block is modulated by the modulation circuit 14, and writing light in accordance with the recording information is applied from the semiconductor laser diode 15 to the optical disk 2 by controlling the laser control circuit 13. Thereby, data in units of ECC blocks are successively recorded on the optical disk 2.

During recording, the focusing control circuit 24 and the tracking control circuit 25 perform focusing control and tracking control, respectively, in according with the focusing error signal and the tracking error signal. However, there are cases where the focusing error signal or the tracking error signal abnormally increases, due to power noise, disturbance such as vibration, and defects of the disk such as flaws and warp. In such cases, a write error occurs and it is determined that information recording has ended in failure.

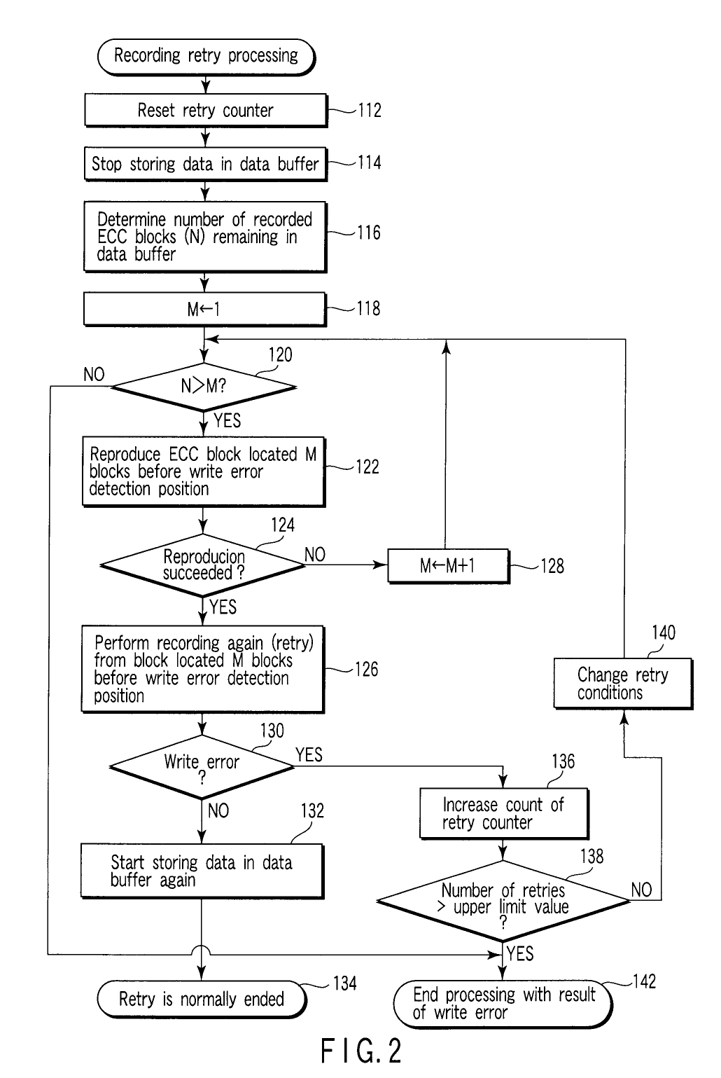

Therefore, according to the embodiment, when a focusing error signal or a tracking error signal exceeds a predetermined value, recording operation is stopped, and recording is performed again (recording retry processing), as illustrated in a flowchart of FIG. 2.

In block 112, a retry counter is reset. This is performed to control (limit) the number of recording retries. In block 114, data storing into the data buffer is stopped to prevent rewriting data in the data buffer.

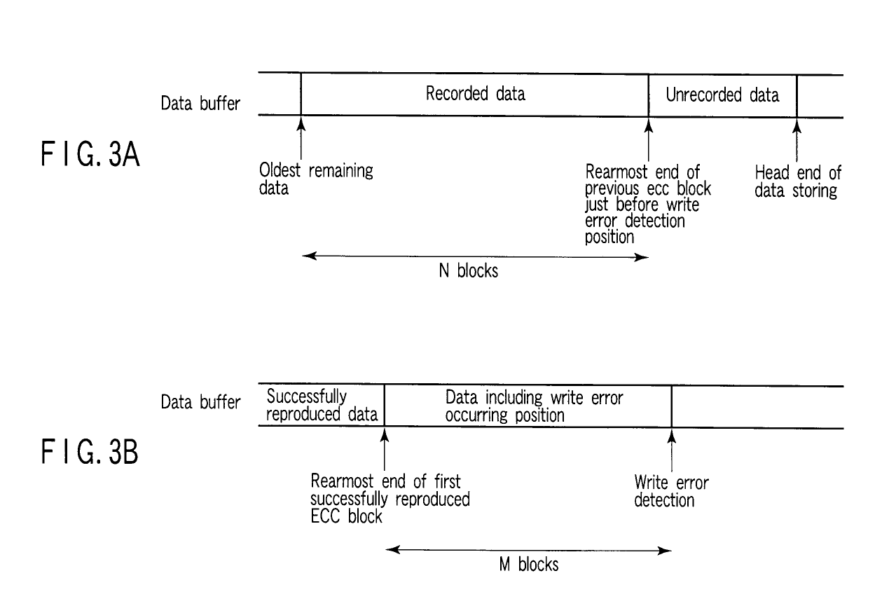

FIGS. 3A and 3B illustrate correlation between data in the data buffer and data on the disk. FIG. 3A illustrates data stored in the data buffer in a data stream. The leftmost data is the oldest data, and the rightmost data is the newest data. When a write error is detected, recording is immediately stopped. Therefore, when storing of data in the data buffer is stopped, old data in the data buffer is recorded data, and new data is unrecorded data. Since recording of the ECC block in which a write error is detected is stopped in midstream, the ECC block is unrecorded. Therefore, the newest recorded data is the previous ECC block just before the write error detection position. To perform recording again (recording retry), it is required that the recorded data in the position where a write error occurs remains in the data buffer. However, if the recording speed is high and the write error detection speed is low, a write error may be detected long time after the write error occurs. Further, if the data buffer has a small capacity, there are cases where the recorded data in the position where the write error has occurred does not remain in the data buffer and recording retry cannot be performed.

Therefore, in block 116, the number N of recorded ECC blocks remaining in the data buffer is obtained. Then, in block 118, 1 is set as a variable M. Although the details are explained later, the variable M is the number of ECC blocks from the write error detection position to the first ECC block in which reproduce success is detected, as illustrated in FIG. 3B. In other words, M is the number of blocks of a region including the write error occurring position. Then, in block 120, it is determined whether N is larger than M or not. If N is not larger than M, the recorded data in the write error occurring position does not remain in the data buffer, it is determined that recording retry is impossible, and the processing is ended with a result of write error in block 142.

If N is larger than M in block 120, an ECC block which is located M blocks (1 block in the first processing) before the block including the write error detection position is reproduced in block 122. In block 124, the error correction circuit 31 determines whether reproduce of the block has succeeded (recording has been normally performed) or not. It is determined that reproduce has succeeded when the error correction circuit 31 can perform error correction of the reproduce signal, and it is determined that reproduce has ended in failure when the error correction circuit 31 cannot perform error correction. If reproduce does not succeed, M is incremented by 1 (+1) in block 128, and the flow goes back to the determination in block 120. Specifically, the blocks are searched from the write error detection position in reverse chronological order until reproduce succeeds, to find the first ECC block in which reproduce success is detected. When success in reproduce is first detected in an ECC block which is located M blocks before the write error detection position, the range of data including the error occurring part includes M blocks, as illustrated in FIG. 3B.

When success in reproduce is detected in block 124, M ECC blocks chronologically prior to the write error detection position are overwritten again (recording retry) in block 126. As in the normal recording operation, there are also cases in the recording retry where a focusing error signal or a tracking error signal abnormally increases, a write error occurs and information recording ends in failure. Therefore, it is determined in block 130 whether a write error occurs in the recording retry. If no write error occurrence is detected, storing of data into the data buffer is started again in block 132, and recording retry is normally ended in block 134.

If a write error occurrence in recording retry is detected in block 130, the retry counter is incremented (+1) in block 136, and it is determined in block 138 whether the number of retries exceeds the upper limit value or not. If the number of retries exceeds the upper limit value, it is determined that no more recording retries can be performed, and the processing is ended with a result of write error in block 142. If the number of retries does not exceed the upper limit value, recording conditions in retry are changed in block 140, and the flow goes back to block 120. Write errors are caused by disturbance noise such as vibration, power noise, defects, small flaws and dust on the optical disk. Although retry of data including a write error caused by disturbance noise or power noise may succeed without changing the recording conditions, retry of data including a write error caused by defects and flaws never succeeds without changing the recording conditions.

The recording power is generally increased when it is changed. Write errors due to defects, flaws and dust are solved with high possibility by increasing the recording power. The recording conditions include servo conditions and recording power. The servo conditions include gains of a tracking servo and a focusing servo, and an equalizing frequency. If the recording medium is warped, trackability is improved by increasing the gains, and it is highly possible that retry succeeds. It is preferable not to track defects, flaws and dust, and trackability is reduced by lowering the gains. The trackability is improved by increasing the equalizing frequency, and reduced by lowering the equalizing frequency.

As described above, according to the first embodiment, when a write error occurrence is detected, ECC blocks of the recorded area on the disk are reproduced one by one from the detection position in reverse chronological order. The first block which can be reproduced is detected, and thereby a region including a block in which the write error may have occurred can be identified. Recording of the region is retried, and thereby data can be correctly recorded in a rewritable optical disk, and the write error is compensated. Further, changing the recording conditions in recording retry increases the possibility of correctly recording data by recording retry.

The following is explanation of information recording apparatuses and information recording methods according to other embodiments of the present invention. In the following embodiments, constituent elements which are the same as those in the first embodiment are denoted by the same respective reference numerals, and detailed explanation thereof is omitted.

### SECOND EMBODIMENT

A block diagram of the second embodiment is omitted, since it is the same as the block diagram of the first embodiment.

In the first embodiment, ECC blocks of the recorded area on the disk are reproduced one by one from the detection position in reverse chronological order, the first block which can be reproduced is detected, and thereby a region including a block in which the write error may have occurred is identified. The second embodiment has a structure in which ECC blocks are reproduced one by one in chronological order (toward the current block) from the block of the oldest recorded data remaining in the data buffer, the first block which cannot be reproduced is detected, and thereby a region including a block in which a write error may have occurred is identified.

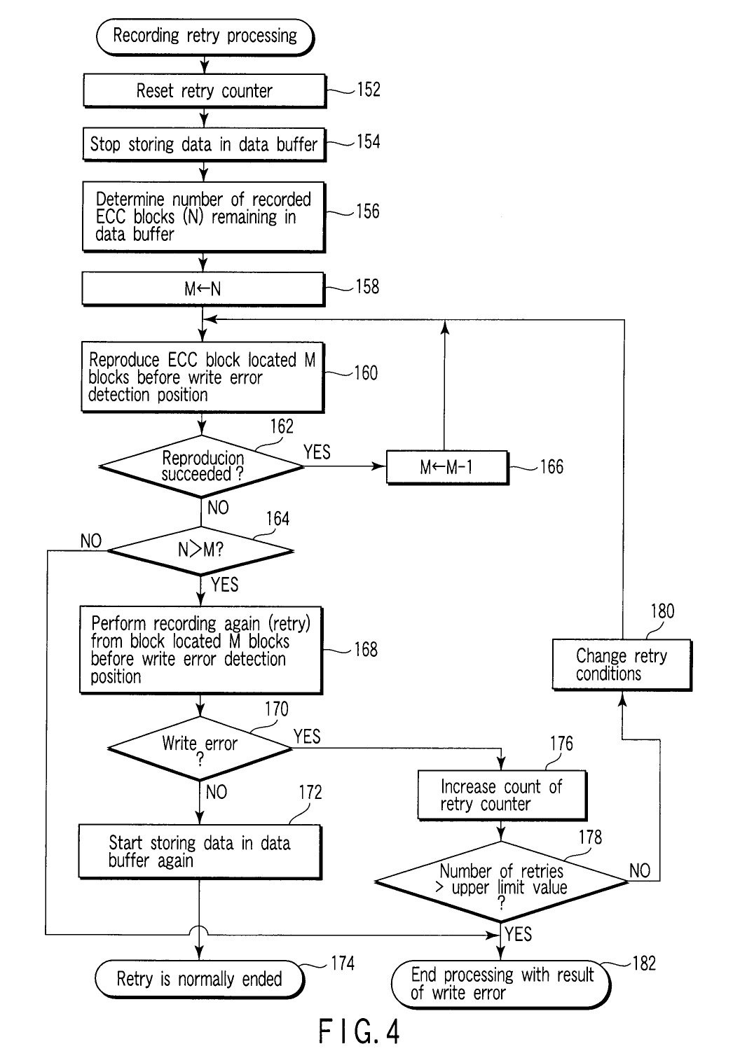

FIG. 4 illustrates a flowchart of recording retry processing according to the second embodiment. First, in block 152, a retry counter is reset. In block 154, storing of data into the data buffer is stopped, and rewriting of data in the data buffer is prevented. In block 156, the number (N) of recorded ECC blocks remaining in the data buffer is obtained. In block 158, N is set as a variable M. In block 160, an ECC block located M blocks (N blocks in first processing) before the write error detection position is reproduced. In block 162, the error correction circuit 31 determines whether reproduce has succeeded (recording has been normally performed). When the error correction circuit 31 successively performs error correction of the reproduce signal, it is determined that reproduce has succeeded. When error correction is impossible, it is determined that reproduce has ended in failure. When reproduce ends in failure, M is decremented by 1 (−1) in block 166, and the flow goes back to block 160. In block 160, newer ECC blocks are successively reproduced in chronological order, and the first block which cannot be reproduced is detected.

When reproduce failure is detected in block 162, the value M being used is the number of blocks of the region including the write error occurring position, as in the first embodiment. Therefore, it is determined in block 164 whether N is larger than M. If N is not larger than M, the recorded data of the write error occurring position does not remain in the data buffer. Therefore, it is determined that recording retry is impossible, and the processing is ended with a result of write error in block 182.

If N is larger than M in block 164, M blocks chronologically prior to the write error detection position are overwritten again (recording retry) in block 168. As in the normal recording operation, there are also cases in the recording retry where a focusing error signal or a tracking error signal abnormally increases, a write error occurs and information recording ends in failure. Therefore, it is determined in block 170 whether a write error occurs in the recording retry. If no write error occurrence is detected, storing of data into the data buffer is started again in block 172, and the recording retry is normally ended in block 182.

If a write error occurrence in recording retry is detected in block 170, the retry counter is incremented (+1) in block 176, and it is determined in block 178 whether the number of retries exceeds the upper limit value or not. If the number of retries exceeds the upper limit value, it is determined that no more recording retries can be performed, and the processing is ended with a result of write error in block 182. If the number of retries does not exceed the upper limit value, recording conditions in retry are changed in block 180, and the flow goes back to block 160.

As described above, according to the second embodiment, when occurrence of a write error is detected, ECC blocks in the recorded area on the disk are chronologically (toward the current block) reproduced one by one from the first block located N blocks (the number of recorded data blocks stored in the data buffer) prior to the error detection position. The first block which cannot be reproduced is detected, and thereby a region including a block in which the write error may have occurred can be identified. Recording of the region is retried, and thereby data can be correctly recorded in a rewritable optical disk, and the write error is compensated. Further, changing the recording conditions in recording retry increases the possibility of correctly recording data by recording retry.

### THIRD EMBODIMENT

A block diagram of the third embodiment is omitted, since it is the same as the block diagram of the first embodiment.

In the first and the second embodiments, when a write error is detected, a region including a block in which the write error may exist is identified, and recording of only the region is retried. In the third embodiment, the region is not identified, but all the recorded data remaining in the data buffer is recorded again, when an ECC block of the oldest recorded data remaining in the data buffer does not fall within a region including a write error.

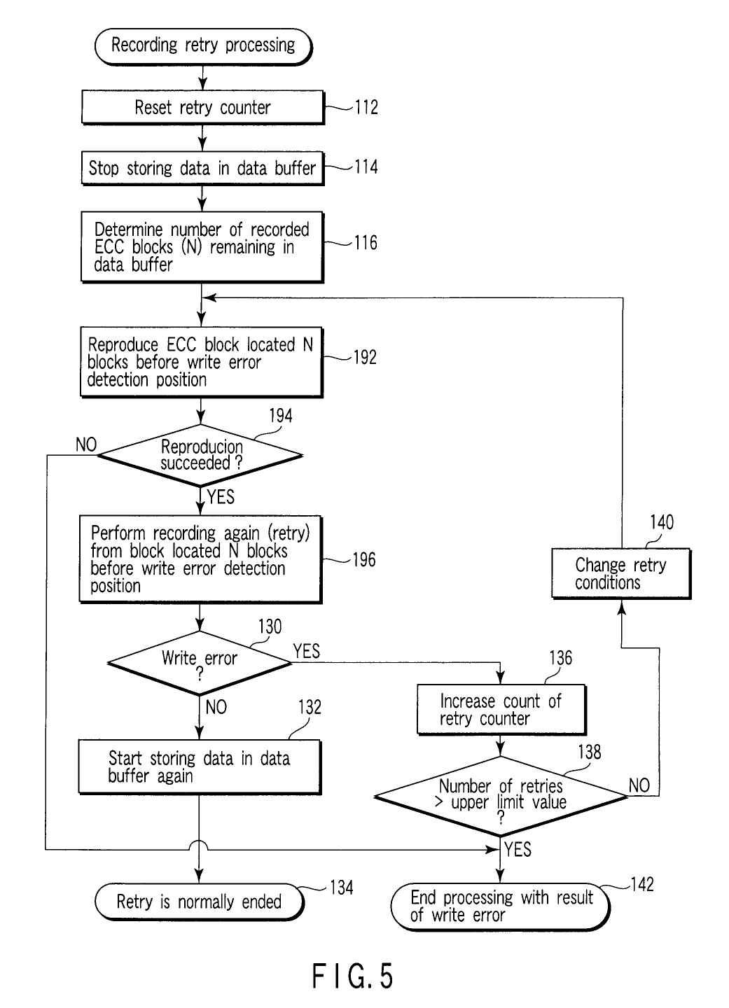

FIG. 5 illustrates a flowchart of recording retry processing according to the third embodiment. Blocks which are the same as those in the flowchart of FIG. 2 according to the first embodiment are denoted by the same respective reference numerals.

In block 112, a retry counter is reset. In block 114, storing of data into the data buffer is stopped, and rewriting of data in the data buffer is prevented. In block 116, the number (N) of recorded ECC blocks remaining in the data buffer is determined.

In block 192, an ECC block located N blocks before a block including a write error detection position is reproduced. In block 194, the error correction circuit 31 determines whether the reproduce has succeeded (whether recording has been normally performed). When the error correction circuit 31 successively performs error correction of the reproduce signal, it is determined that the reproduce has succeeded. When the error correction circuit 31 fails in error correction, it is determined that reproduce has ended in failure. If the reproduce does not succeed, the oldest data in the data buffer is a part of data including the write error occurring position, and the recorded data of the write error occurring position does not remain in the data buffer. Therefore, it is determined that recording retry is impossible, and the processing is ended in block 142 with a result of write error.

If reproduce succeeds in block 194, N ECC blocks prior to the write error detection position are chronologically overwritten again (recording retry) in block 196. As in the normal recording operation, there are also cases in the recording retry where a focusing error signal or a tracking error signal abnormally increases, a write error occurs and information recording ends in failure. Therefore, it is determined in block 130 whether a write error occurs in the recording retry. If no write error occurrence is detected, storing of data into the data buffer is started again in block 132, and recording retry is normally ended in block 134.

If a write error occurrence in recording retry is detected in block 130, the retry counter is incremented (+1) in block 136, and it is determined in block 138 whether the number of retries exceeds the upper limit value or not. If the number of retries exceeds the upper limit value, it is determined that no more recording retries can be performed, and the processing is ended with a result of write error in block 142. If the number of retries does not exceed the upper limit value, recording conditions in retry are changed in block 140, and the apparatus goes back to block 192.

As described above, according to the third embodiment, when occurrence of a write error is detected, a region including a block in which the write error may exist is not identified, but all the recorded data remaining in the data buffer is recorded again, when the ECC block of the oldest recorded data remaining in the data buffer does not fall within a region including a write error. Thereby, it is possible to retry recording of a region including a block in which the write error may have occurred. Therefore, data can be correctly recorded in a rewritable optical disk, and the write error is compensated. Further, changing the recording conditions in recording retry increases the possibility of correctly recording data by recording retry.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information recording apparatus comprising:
a recording unit configured to record information in blocks of a predetermined size in a rewritable information recording medium;
a write error detector configured to detect a write error;
a buffer configured to store recording information of blocks while performing update, and to stop the update of information when the write error detector detects the write error;
an identifying unit configured to play back recording information of the information recording medium corresponding to the blocks stored in the buffer when the write error detector detects the write error, and to identify a block including a write error occurring position based on whether a playback of the recording information has succeeded or not; and
a re-recording unit configured to re-record the block identified by the identifying unit.

2. An information recording apparatus according to claim 1, wherein
the recording unit comprises an optical pickup which performs recording by applying a light beam to an optical disk, and
the write error detector detects the write error when a level of at least one of a focusing error signal and a tracking error signal from the optical pickup exceeds a predetermined level.

3. An information recording apparatus according to claim 1, wherein
the recording unit performs recording for each error detection and correction block, and
the identifying unit successively plays back old blocks in reverse chronological order from a previous error detection and correction block just before a write error detection position, determines whether reproduce has succeeded or not according to whether reproduce information is error-correctable or not, and identifies a region ranging from a first error detection and correction block, reproduce of which has succeeded, to the previous error detection and correction block just before the write error detection position as the block including the error occurring position.

4. An information recording apparatus according to claim 1, wherein
the recording unit performs recording for each error detection and correction block, and
the identifying unit successively plays back new blocks in chronological order from an error detection and correction block located the blocks before the write error detection position, determines whether reproduce has succeeded or not according to whether reproduce information is error-correctable or not, and identifies a region ranging from a first error detection and correction block, reproduce of which ends in failure, to a previous error detection and correction block just before the write error detection position as the block including the error occurring position.

5. An information recording apparatus according to claim 1, wherein
the re-recording unit performs re-recording under recording conditions different from recording conditions of the recording unit.

6. An information recording apparatus according to claim 5, wherein
the recording unit comprises an optical pickup which performs recording by applying a light beam to an optical disk, and
the recording conditions comprise at least one of recording power of the light beam and servo conditions of the optical pickup.

7. An information recording apparatus according to claim 1, wherein
the re-recording unit repeats recording up to a predetermined number of times when the write error detector detects the write error in re-recording.

8. An information recording apparatus comprising:
a recording unit configured to record information in blocks of a predetermined size in a rewritable information recording medium;
a write error detector configured to detect a write error;
a buffer configured to store recording information of blocks while performing update, and to stop the update of information when the write error detector detects the write error; and
re-recording unit configured to re-record the blocks stored in the buffer when the write error detector detects the write error.

9. An information recording method comprising:
recording information in blocks of a predetermined size in a rewritable information recording medium;
detecting a write error;
storing recording information of blocks while performing update, and stopping the update of information when the write error is detected;
playing back recording information of the information recording medium corresponding to the stored blocks when the write error is detected, and identifying a block including a write error occurring position based on whether a playback of the recording information has succeeded or not; and
re-recording the identified block.

10. An information recording method comprising:
recording information in blocks of a predetermined size in a rewritable information recording medium;
detecting a write error;
storing recording information of blocks while performing update, and stopping the update of information when the write error is detected; and
re-recording the blocks stored in the buffer when the write error is detected.
